(19) United States
(12) Patent Application Publication
(10) Pub. No.: US 2011/0307250 A1
(43) Pub. Date: Dec. 15, 2011

(54) Modular Speech Recognition Architecture

(75) Inventor: Robert D. Sims, Milford, MI (US)

(73) Assignee: GM Global Technology Operations, Inc., Detroit, MI (US)

(21) Appl. No.: 12/797,977

(22) Filed: Jun. 10, 2010

(51) Int. Cl. G10L 15/00; G10L 21/00

(52) U.S. Cl. 704/231; 704/275; 704/E15.001; 704/E21.001; 704/E11.001

(57) ABSTRACT

A speech recognition system is provided. The speech recognition system includes a speech recognition module; a plurality of domain specific dialog manager modules that communicate with the speech recognition module to perform speech recognition; and a speech interface module that that communicates with the plurality of domain specific dialog manager modules to selectively enable the speech recognition.

### FIELD OF THE INVENTION

Exemplary embodiments of the present invention are related to speech recognition systems, and more specifically, to speech recognition systems and methods for vehicle applications.

### BACKGROUND

Speech recognition converts spoken words to text. Various speech recognition applications make use of the text to perform data entry, to control componentry, and/or to create documents.

Vehicles, for example, may include multiple applications with speech recognition capabilities. For example, systems such as, navigation systems, radio systems, telematics systems, phone systems and, media systems may each include a speech recognition application. Each speech recognition application is independently developed and tested before being incorporated into the vehicle architecture. Such independent development and testing can be redundant and time consuming. Accordingly, it is desirable to provide a single speech recognition system that can be applicable to the systems of the vehicle.

### SUMMARY OF THE INVENTION

In one exemplary embodiment, a speech recognition system is provided. The speech recognition system includes a speech recognition module; a plurality of domain specific dialog manager modules that communicate with the speech recognition module to perform speech recognition; and a speech interface module that communicates with the plurality of domain specific dialog manager modules to selectively enable the speech recognition.

The above features and advantages and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is an illustration of a vehicle including a modular speech recognition system in accordance with an exemplary embodiment;

FIGS. 2 through 6 are dataflow diagrams illustrating the modular speech recognition system in accordance with exemplary embodiments; and

FIGS. 7 through 9 are sequence diagrams illustrating modular speech recognition methods in accordance with an exemplary embodiment.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments of the present invention a modular speech recognition system 10 is shown to be included within a vehicle 12 having multiple speech dependent applications. Such applications may include, for example, but are not limited to, a phone application 14, a navigation application 16, a media application 18, a telematics application 20, a network application 22, or any other speech application for vehicles. As can be appreciated, the modular speech recognition system 10 can be applicable to various other systems having multiple speech dependent applications and thus, is not limited to the present vehicle example.

Generally speaking, the modular speech recognition system 10 manages speech input received from, for example, a microphone 24. In the present example, the speech input is provided by a driver or passenger of the vehicle 12 to interact with one or more of the speech dependent applications 14-22. The modular speech recognition system 10 is implemented according to a modularized system architecture that accommodates each of the various speech recognition domains. The modularized system allows for various applications to connect to and utilize the speech recognition system 10. For example, control logic for a particular domain that is related to a particular application can be individually developed and/or calibrated. When that domain or application is incorporated into the vehicle 12, the control logic can be loaded to the modular speech recognition system 10 or can be accessed by the modular speech recognition system 10, for example, over a network 26. The network 26 can be any wired or wireless network within or outside of the vehicle 12. In this manner, the control logic for each application or domain can be updated without altering the speech recognition functionality.

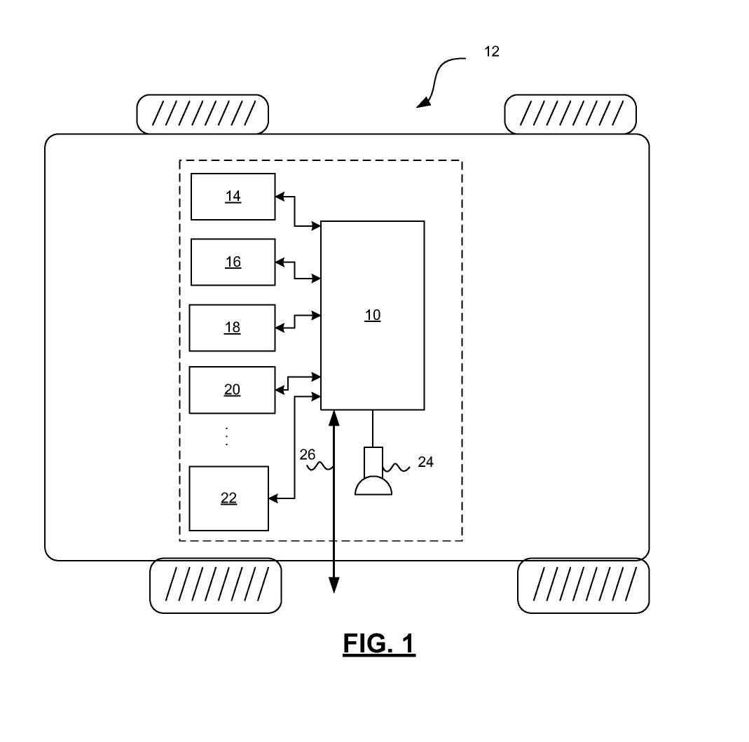

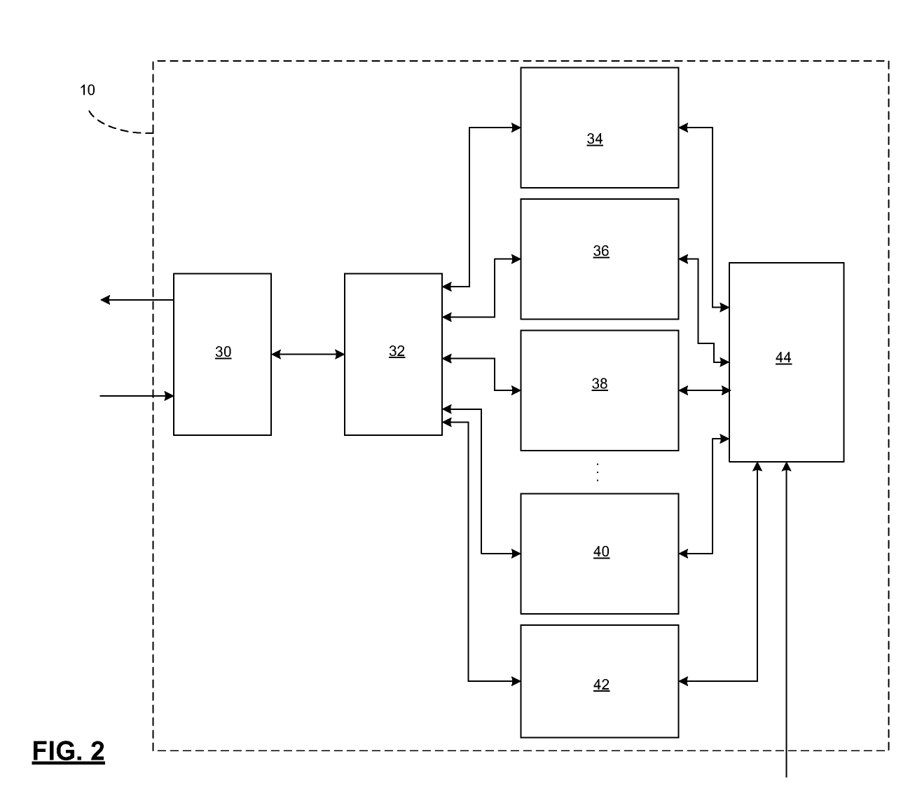

Referring now to FIGS. 2 through 6, dataflow diagrams illustrate the modular speech recognition system 10 in accordance with various embodiments. As can be appreciated, various embodiments of modular speech recognition systems 10, according to the present disclosure, may include any number of modules. The modules shown in FIG. 2 may be combined and/or further partitioned to similarly manage speech recognition for the plurality of speech dependent applications 14-22. Inputs to the modular speech recognition system 10 may be received from one or more sensory inputs of the vehicle 12 (FIG. 1), received from other modules (not shown) within the vehicle 12 (FIG. 1), determined/modeled by other modules (not shown) within the modular speech recognition system 10, and/or received from an external source over a network (e.g., the Internet).

In various embodiments, the modular speech recognition system 10 includes a human machine interface (HMI) module 30, a speech interface module 32, one or more domain specific dialog manager modules 34-42, and a speech recognition module 44. The domain specific dialog manager modules can include, for example, but are not limited to, a phone dialog manager module 34, a navigation dialog manager module 36, a media dialog manager module 38, a telematics dialog manager module 40, and a network dialog manager module 42.

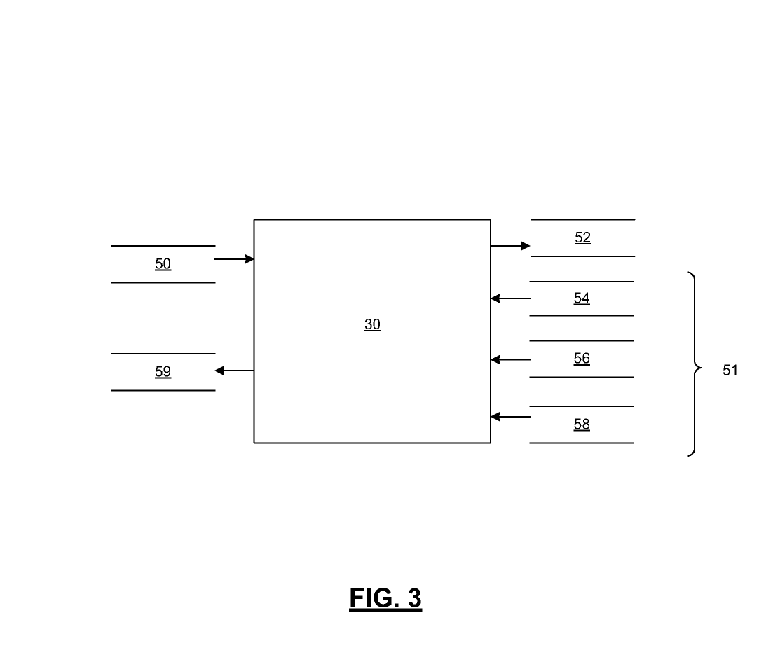

The HMI module 30 interfaces with the speech interface module 32. The HMI module 30 manages the interaction between a user interface of the speech dependent application 14-20 (FIG. 1) and the user. For example, as shown in FIG. 3, the HMI module 30 receives as input user input 50. The user input 50 can be generated based on a user's interaction with a user interface of the speech dependent application 14-20 (FIG. 1). Based on the user input 50, the HMI module 30 determines when speech recognition is desired and generates a request to enable the speech recognition. The request can include a speech button identifier 52 that identifies which application is requesting the speech recognition. After the speech recognition has been enabled, the HMI module 30 provides display feedback or controls one or more features of the speech dependent application 14-20 (FIG. 1) via display/action 59 based on speech recognition information 51. The speech recognition information 51 can be received from the speech interface module 32. As will be discussed in more detail below, the speech recognition information 51 can include a speech display 54, a speech action 56, and an HMI state 58.

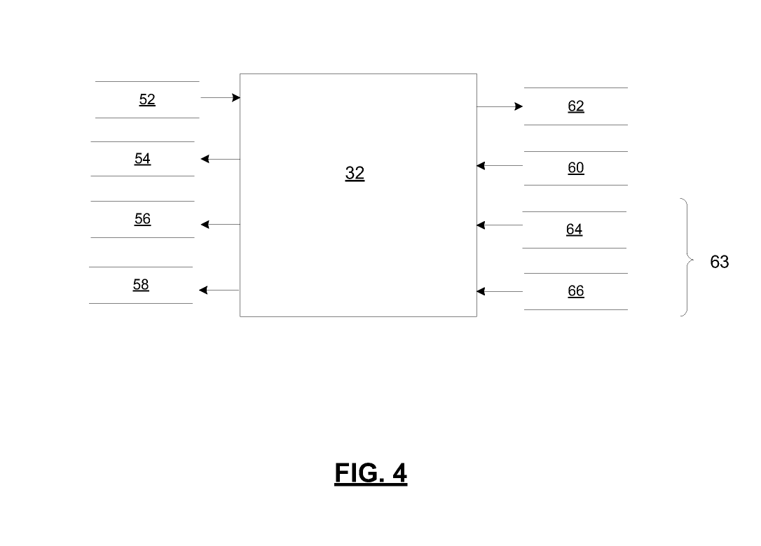

With reference back to FIG. 2, the speech interface module 32 interfaces with the HMI module 30 and the various domain specific dialog manager modules 34-42 to coordinate the speech recognition. For example, as shown in FIG. 4, the speech interface module 32 manages incoming requests from the HMI module. The incoming requests may include requests to enable speech recognition such as, for example, the speech button identifiers 52. In various embodiments, the incoming requests may include context specific domain information.

Based on the incoming requests, the speech interface module 32 coordinates with one or all of the domain specific dialog manager modules 34-42 to carry out the speech recognition. For example, the speech interface module 32 can receive domain information 60 from the domain specific dialog manager modules 34-42 that includes the available grammar lists or language models for the top commands associated with the domains. Based on the speech button identifier 52 and the domain information 60, the speech interface module 32 can send a load command 62 for all domain specific dialog manager modules 34-42 to load a top level grammar and/or language model or a load command 62 to load a grammar associated with a specific event of a particular domain.

The speech interface module 32 further manages feedback information 63 from the domain specific dialog manager modules 34-42. As will be discussed in further detail below, the feedback information 63 may include display feedback 64 and a current state 66. Based on the feedback information 63, the speech interface module 32 reports the speech recognition feedback information to the HMI module 30 through a speech display 54, a speech action 56, and/or an HMI state 58. The speech display 54 includes the display information to display the recognized results. The speech action 56 includes speech recognition information for controlling speech enabled components (e.g., tuning the radio, playing music, etc.) The HMI state 58 includes the current state of the system HMI.

With reference back to FIG. 2, the various domain specific dialog manager modules 34-42 interface with the speech interface module 32 and the speech recognition module 44. Each domain specific dialog manager module 34-42 controls the dialog between the user and the user interface based on domain specific control logic. The control logic can include, but is not limited to, display logic, speech recognition logic, and error logic. In various embodiments, each domain specific dialog manager module 34-42 includes one or more grammars, and a language model for that specific domain. The domain specific dialog manager modules 34-42 control the speech recognition based on the speech recognition logic, the grammar, and the language model.

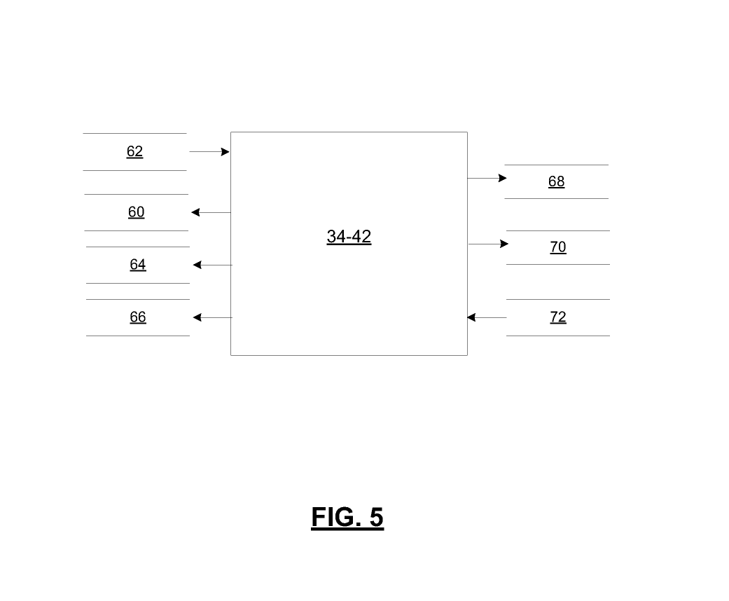

As shown in FIG. 5, each domain dialog manager module 34-42 can provide to the speech interface module 32 domain information 60. The domain information 60 can include, but is not limited to, control button identifiers associated with that domain, and a list of the available grammars and/or language models from that module. In return, the domain specific dialog manager module 34-42 can receive a load command 62 to load one or more grammars and/or language modules to the speech recognition module 44.

Each domain specific dialog manager module 34-42 communicates the grammar and/or language model 70 and a grammar control request 68 to the speech recognition module 44 based on the speech recognition logic and the load command 62. In return, the domain specific dialog manager module 34-42 receives a recognized result 72 from the speech recognition module 44. Each domain specific dialog manager module 34-42 determines the display feedback 64 and the current state 66 based on the recognized result 72 and the display logic and/or the error logic.

In various embodiments, one or more domain specific dialog manager modules 34-40 can be replaced by or used as the network interface module 42. As can be appreciated, the control logic, the grammar, and/or the language model can be part of the network interface module 42 similar to the other domain specific dialog manager modules. Alternatively, the control logic can be remotely located and can be communicated with via the network interface module 42. In various other embodiments, the network interface module 42 can include control logic for communicating between modules. For example, if module A contains specific speech recognition HMI logic, the module A can communicate with module B using the network interface dialog manager module 42.

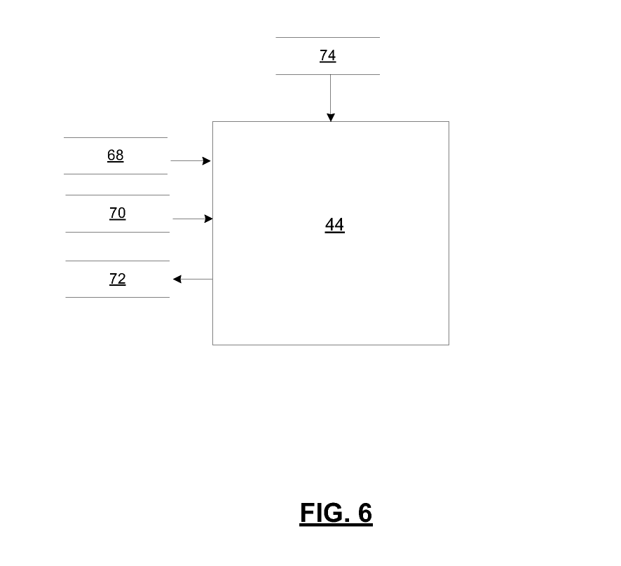

With reference back to FIG. 2, the speech recognition module 44 interfaces with each of the domain specific dialog manager modules 34-42. The speech recognition module 44 performs speech recognition on speech uttered by the user. For example, as shown in FIG. 6, the speech recognition module 44 receives as input the speech command 74 uttered by the user. The speech recognition module 44 performs speech recognition on the speech command 74 based on the grammar and/or the language model 70 received from the domain specific dialog manager module 34-42. The speech recognition module 44 selectively loads a particular grammar to be used in the speech recognition process based on the grammar control request 68 issued by the specific dialog manager module 34-42. The grammar control request 68 may include a request for particular statistical language model. The speech recognition module 44 then generates the recognized result 72. The recognized result 72 can include, for example, a result and/or a current state of the recognition process. The recognized result 72 can be communicated to the requesting domain specific dialog manager module 34-42.

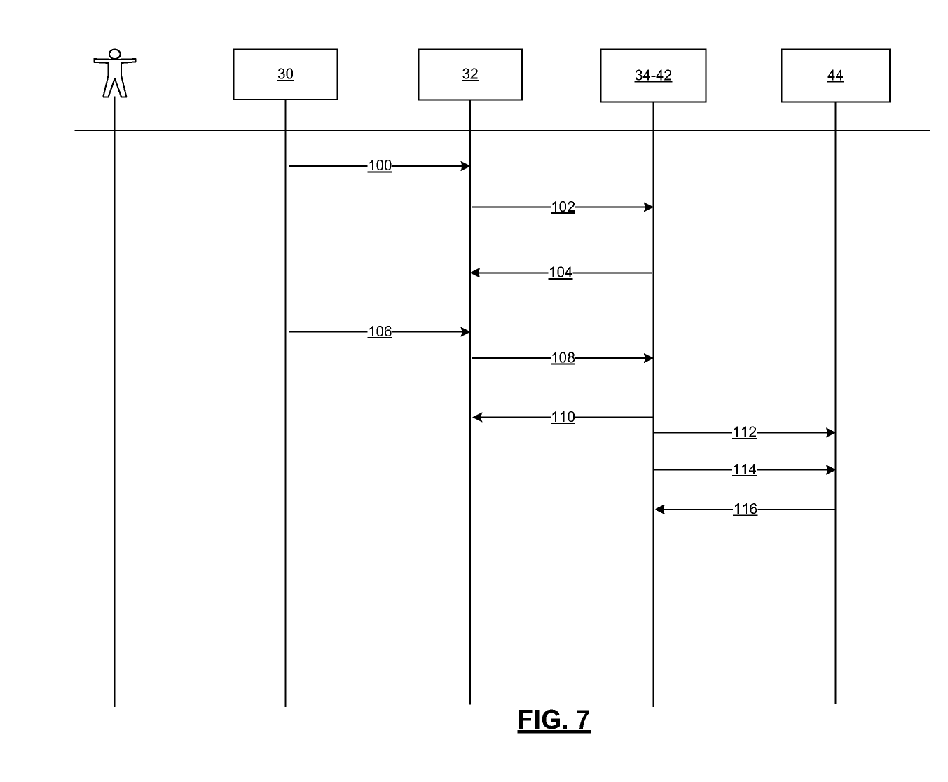

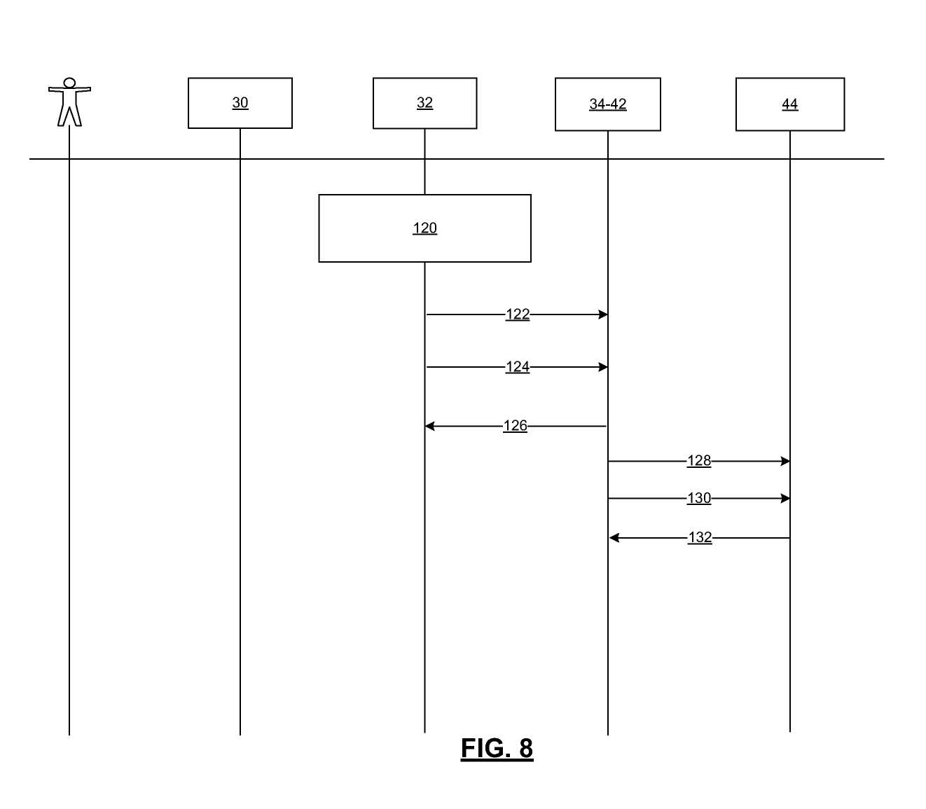

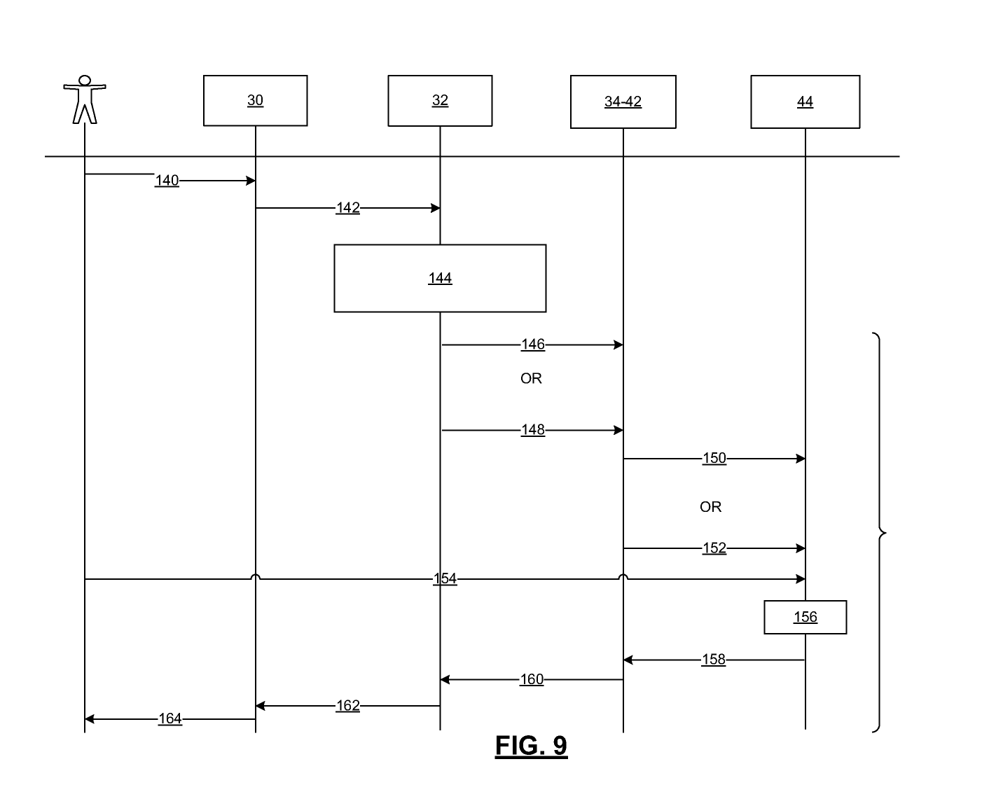

Referring now to FIGS. 7 through 9, sequence diagrams illustrate speech recognition methods that can be performed by the module speech recognition system 10 (FIG. 1) in accordance with exemplary embodiments. In particular, FIG. 7 illustrates an initialization method in accordance with an exemplary embodiment. FIG. 8 illustrates a download manager method in accordance with an exemplary embodiment. FIG. 9 illustrates a speech interaction method in accordance with an exemplary embodiment.

As shown in FIG. 7, upon initialization by the HMI module 30 of a loaded dialog manager module at 100, the speech interface module 32 requests domain specific control information at 102. The particular dialog manager module 34-42 returns the domain specific control information at 104. Upon initialization of a remote dialog manager module at 106, the speech interface module 32 requests domain specific control information at 108. The dialog manager module 34-42 returns the domain specific control information at 110. The dialog manager module 34-42 then sends and registers its grammar to the speech recognition module 44 at 112 and 114. Upon completion of the registration, the speech recognition module 44 acknowledges that the registration is complete at 116.

As shown in FIG. 8, the sequence begins with the speech interface module 32 performing a download of a particular dialog manager module 34-42 from some external source at 120. Upon completion of the download, the speech interface module 32 generates a request to create or replace an interface associated with the dialog manager module 34-42 and/or a request to get domain specific interface information at 122 and 124. The dialog manager module 34-42 returns the domain specific interface information at 126. The dialog manager module 34-42 then provides and registers its grammar to the speech recognition module 44 at 128 and 130. Upon completion of the registration, the speech recognition module 44 acknowledges that the registration is complete at 132. After the download of the dialog manager module 34-42, the dialog manager module 34-42 can be saved unless it is replaced or removed. After the download, the regular domain initialization can be performed, as shown in FIG. 7.

As shown in FIG. 9, the sequence begins with a user pressing a speech button of the user interface at 140. The HMI module 30 then calls the speech event based on the speech button identifier at 142. The speech interface module 32 determines if the speech event relates to a specific dialog manager module 34-42 at 144. If the speech event relates to a specific dialog manager module 34-42, the speech interface module 32 calls the dialog manager module specific event at 146. If, however, the speech event does not relate to a specific dialog manager module 34-42, the speech interface module 32 calls all the dialog manager modules to load a top level grammar at 148. The grammars and/or language models are loaded at 150 or 152. The user then utters a speech command at 154. Using the loaded grammar, the speech recognition module 44 performs speech recognition on the utterance at 156. The speech recognition module 44 returns the recognized results to the dialog manager module at 158. The dialog manager module notifies the speech interface module 32 of the results at 160. The speech interface module 32 notifies the HMI module of the results at 162. And the viewer views the results at 164. The sequence continues until the dialog is complete.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A speech recognition system, comprising:
a speech recognition module;
a plurality of domain specific dialog manager modules that communicate with the speech recognition module to perform speech recognition; and
a speech interface module that communicates with the plurality of domain specific dialog manager modules to selectively enable the speech recognition.

2. The system of claim 1 further comprising a human machine interface (HMI) module that communicates with the speech interface module based on user input.

3. The system of claim 2 wherein the speech interface module communicates speech recognition results to the HMI module.

4. The system of claim 3 wherein the domain specific dialog manager modules communicate the speech recognition results to the speech interface module.

5. The system of claim 1 wherein the plurality of domain specific dialog manager modules each include domain specific control logic.

6. The system of claim 5 wherein the domain specific control logic includes at least one of display logic, error logic, and speech recognition logic.

7. The system of claim 1 wherein the plurality of domain specific dialog manager modules include at least one grammar.

8. The system of claim 1 wherein the plurality of domain specific dialog manager modules include a language model.

9. The system of claim 1 wherein the plurality of domain specific dialog manager modules includes at least one of a phone dialog manager module, a navigation dialog manager module, a media dialog manager module, a telematics dialog manager module.

10. The system of claim 1 wherein at least one of the plurality of domain specific dialog manager modules includes a network interface manager module.

11. A vehicle, comprising:
a plurality of speech enabled applications; and
a speech recognition system that communicates with each of the plurality of speech enabled applications to perform speech recognition.

12. The vehicle of claim 11 wherein the speech recognition system includes a plurality of domain specific dialog manager modules that are each associated with at least one of the plurality of speech enabled applications.

13. The vehicle of claim 12 wherein the speech recognition system further includes a speech interface module that that communicates with the plurality of domain specific dialog manager modules to selectively enable the speech recognition.

14. The vehicle of claim 13 wherein the speech recognition system further includes a human machine interface (HMI) module that communicates with the speech interface module based on user input.

15. The vehicle of claim 12 wherein the plurality of domain specific dialog manager modules each include domain specific control logic.

16. The vehicle of claim 15 wherein the domain specific control logic includes at least one of display logic, error logic, and speech recognition logic.

17. The vehicle of claim 12 wherein the plurality of domain specific dialog manager modules include at least one grammar.

18. The vehicle of claim 12 wherein the plurality of domain specific dialog manager modules include a language model.

19. The vehicle of claim 12 wherein the plurality of domain specific dialog manager modules includes at least one of a phone dialog manager module, a navigation dialog manager module, a media dialog manager module, a telematics dialog manager module.

20. The vehicle of claim 12 wherein at least one of the plurality of domain specific dialog manager modules includes a network interface manager module.
